(19) United States
(12) Patent Application Publication
(10) Pub. No.: US 2025/0164822 A1
(43) Pub. Date: May 22, 2025

(54) COSMETIC CONTACT LENS HAVING AN ELLIPTICAL DOT PATTERN SUITABLE FOR FORMING AN APPARENT LIMBAL RING

(71) Applicant: Johnson & Johnson Vision Care, Inc., Jacksonville, FL (US)

(72) Inventors: Edmund Jolley, Jacksonville, FL (US); Ashley Nicholl Sever, Jacksonville, FL (US); Anastasia P. Bergen, Jacksonville, FL (US)

(21) Appl. No.: 18/918,530

(22) Filed: Oct. 17, 2024

Related U.S. Application Data
(60) Provisional application No. 63/599,594, filed on Nov. 16, 2023.

(51) Int. Cl. G02C 7/04; G02C 7/02

(52) U.S. Cl. CPC G02C 7/046; G02C 7/021

(57) ABSTRACT

Described are cosmetic contact lenses having features designed to enhance the appearance of the eyes and to optionally correct vision. In particular, cosmetic contact lenses have elliptical dot patterns designed to overlay irises and thereby form apparent limbal rings. For contact lens wearers with uniformly colored irises, such as dark brown irises, these cosmetic contact lenses provide a more texturized appearance to the eyes with apparent limbal rings.

### RELATED APPLICATIONS

This application claims priority to U.S. Provisional Patent Application Ser. No. 63/599,594, filed Nov. 16, 2023, which is incorporated herein by reference in its entirety.

### FIELD OF THE INVENTION

The present invention relates to cosmetic contact lenses which have features designed to enhance the appearance of the eyes of contact lens wearers and to optionally correct refractive errors.

### BACKGROUND OF THE INVENTION

The use of tinted and patterned contact lens to alter the natural color and appearance of the eye for cosmetic purposes is known. Such cosmetic contact lenses are designed to change the color and texture of the iris of the eye. Every person has a unique iris pattern. Every person's unique iris pattern depends on the underlying matrix of collagen fibers and the local concentration of melanin, yielding a variety of concentric or radial bands, which may be either dark or light in color, dark spots of many different geometric shapes, and fibrous web-like structures. Another common feature of the human iris is the limbal ring. A limbal ring is a dark colored ring around the periphery of the iris, creating a distinct border between the iris and the sclera of the eye, providing greater contrast and making the iris appear more colorful.

However, there are people whose irises lack distinct limbal rings, perhaps, because of color and pattern uniformity and location, for example, individuals with dark brown eyes. Accordingly, there is a need for a cosmetic contact lens having a pattern that creates the appearance of a limbal ring for people without an easily recognizable limbal ring, thereby creating a more alluring look.

### SUMMARY OF THE INVENTION

The invention relates to a cosmetic contact lens having an elliptical dot pattern, that creates an apparent limbal ring in its peripheral negative space, when worn on an eye. The apparent limbal ring is formed by a combination of the elliptical dot pattern, the color of the underlying iris in the negative space of the elliptical dot pattern, and the color difference between the elliptical dot pattern and the underlying iris.

In one exemplary aspect, the invention provides a cosmetic contact lens comprising an elliptical dot pattern, wherein the elliptical dot pattern has a diameter equal to or greater than 8 millimeters and has a negative space between 70 percent and 100 percent in an outermost annulus having a thickness between 0.2 millimeters and 2.0 millimeters.

In another exemplary aspect, the invention provides a cosmetic contact lens comprising an elliptical dot pattern, the elliptical dot pattern including a negative space, wherein the negative space creates an apparent limbal ring when the elliptical dot pattern overlays an iris of an eye. The negative space creating the apparent limbal ring can comprise between 70 percent and 100 percent. The thickness of the apparent limbal ring can be between 0.2 millimeters and 2.0 millimeters. The diameter of the elliptical dot pattern can be equal to or greater than 8 millimeters. The diameter of the elliptical dot pattern can correspond to an average iris diameter of a human population, for instance between 9 millimeters and 14 millimeters.

In yet another aspect, the invention provides a cosmetic contact lens further comprising an optical zone in the center of the lens, wherein the optical zone is free of the elliptical dot pattern. The optical zone can be used to correct refractive errors such as myopia, hyperopia, astigmatism, and presbyopia.

In a further aspect, the invention provides a method of designing an elliptical dot pattern comprising the steps (a) selecting a diameter for an elliptical dot pattern, said diameter corresponding to an average iris diameter of a human population; (b) selecting a thickness for an outermost annulus of the elliptical dot pattern between 0.2 millimeters and 2.0 millimeters; and (c) creating an elliptical dot pattern having a negative space between 70 percent and 100 percent in the outermost annulus, wherein the elliptical dot pattern surrounds an optical zone.

In accordance with yet another aspect, the invention provides a process for making a cosmetic contact lens having an elliptical dot pattern suitable for forming an apparent limbal ring comprising the following steps: (a) optionally, pad printing a clear layer onto the front curve mold of a contact lens mold assembly; (b) pad printing one or more print layers on top of the clear layer if present, otherwise on the front curve mold of the contact lens mold assembly, wherein the print layers form an elliptical dot pattern suitable for forming an apparent limbal ring; (c) dispensing a reactive monomer mixture into the front curve mold; (d) positioning a base curve mold on top of the front curve mold, thereby forming the contact lens mold assembly having a cavity in the shape of a contact lens; (e) polymerizing the reactive monomer mixture; (f) removing the cosmetic contact lens from the mold assembly; (g) extracting the cosmetic contact lens; and (h) hydrating the cosmetic contact lens. The cosmetic contact lens can then be packaged and sterilized.

The print layers are formed by using inks with a variety of colorants such as iron oxides, titanium dioxide, mica pigments, phthalocyanines, carbazole violet, and combinations thereof. One attribute of these print layers is that they can form an elliptical dot pattern exhibiting a color difference (ΔE) between 23 and 79 as compared to the color of the iris of the contact lens wearer.

### BRIEF DESCRIPTION OF THE DRAWINGS

FIG. 1 shows a schematic diagram of the elliptical dot pattern and its outermost annulus.

FIG. 2 shows a front planar view of an exemplary cosmetic contact lens.

FIG. 3 shows a left-side view of an exemplary cosmetic contact lens.

FIG. 4 shows a right-side view of an exemplary cosmetic contact lens.

FIG. 5 shows four exemplary print layers A-D that can be used to make elliptical dot patterns.

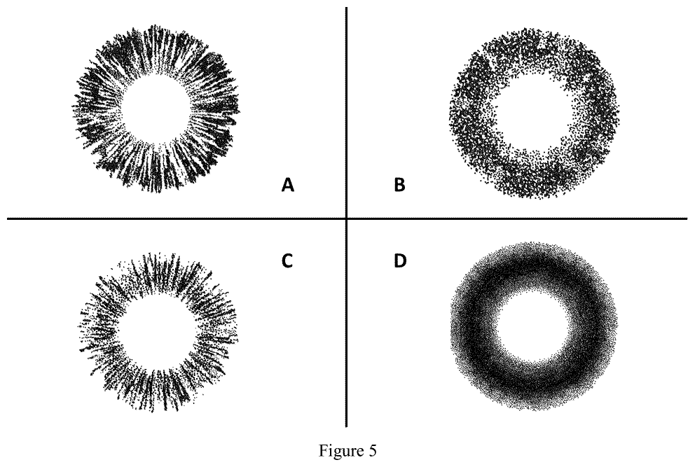

FIG. 6 shows (A) a picture of a representative elliptical dot pattern, (B) a picture of a dark brown eye model, and (C) a picture of a cosmetic contact lens with the same pattern as shown in (A) after being placed on the dark brown eye model shown in (B), showing the apparent limbal ring around the pattern.

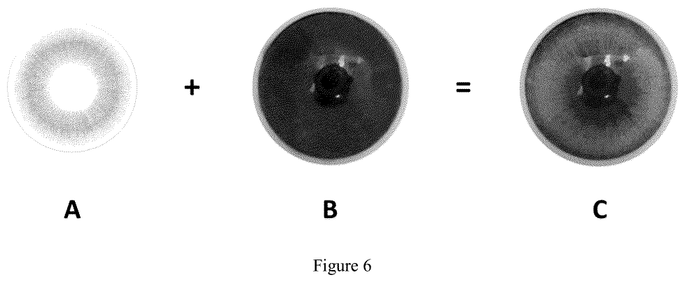

### DETAILED DESCRIPTION OF THE INVENTION

It is to be understood that the invention is not limited to the details of construction or process steps set forth in the following description. The invention is capable of other embodiments and of being practiced or being carried out in various ways using the teaching herein.

### Definitions

With respect to the terms used in this disclosure, the following definitions are provided. Unless defined otherwise, all technical and scientific terms used herein have the same meaning as commonly understood by one of ordinary skill in the art to which the disclosure belongs. The polymer definitions are consistent with those disclosed in the Compendium of Polymer Terminology and Nomenclature, IUPAC Recommendations 2008, edited by: Richard G. Jones, Jaroslav Kahovec, Robert Stepto, Edward S. Wilks, Michael Hess, Tatsuki Kitayama, and W. Val Metanomski. All publications, patent applications, patents, and other references mentioned herein are incorporated by reference.

As used herein, the term “polymerizable” means that the compound comprises at least one polymerizable group. “Polymerizable groups” are groups that can undergo chain growth polymerization, such as free radical polymerization. Non-limiting examples of polymerizable groups (P_{g}) include (meth)acrylates, styrenes, vinyl ethers, (meth)acrylamides, N-vinyllactams, N-vinylamides, O-vinylcarbamates, O-vinylcarbonates, and other vinyl groups. The term “(meth)” designates optional methyl substitution. Thus, a term such as “(meth)acrylate” denotes both methacrylate and acrylate. The polymerizable group may be unsubstituted or substituted. For instance, the nitrogen atom in (meth)acrylamide may be bonded to a hydrogen, or the hydrogen may be replaced with alkyl or cycloalkyl (which themselves may be further substituted). In contrast to “polymerizable,” the term “non-polymerizable” means that the compound does not comprise such a polymerizable group.

A “polymer” is a target macromolecule composed of the repeating units of the monomers and macromers used during polymerization. The phrase “number average molecular weight” refers to the number average molecular weight (Mₙ) of a polymeric sample; the phrase “weight average molecular weight” refers to the weight average molecular weight (Mw) of a polymeric sample; the phrase “polydispersity index” (PDI) refers to the ratio of Mw divided by Mₙ and describes the molecular weight distribution of a polymeric sample. If the type of “molecular weight” is not indicated or is not apparent from the context, then it is intended to refer to the number average molecular weight. The average number of repeating units in a polymeric sample is known as its “degree of polymerization.” When a generic chemical formula of a polymeric sample, such as [***]ₙ is used, “n” refers to its degree of polymerization, and the formula shall be interpreted to represent the number average molecular weight of the polymeric sample.

A “repeating unit” is the smallest group of atoms in a polymer that corresponds to the polymerization of a specific monomer or macromer.

A “homopolymer” is a polymer made from one monomer; a “copolymer” is a polymer made from two or more monomers; a “terpolymer” is a polymer made from three monomers. A “block copolymer” is composed of compositionally different blocks or segments. Diblock copolymers have two blocks. Triblock copolymers have three blocks. “Comb or graft copolymers” are made from at least one macromer.

As used herein, a “monomer” is a mono-functional molecule which can undergo chain growth polymerization, such as free radical polymerization, thereby creating a repeating unit in the chemical structure of the target macromolecule. Some monomers have di-functional impurities that can act as cross-linking agents. A “hydrophilic monomer” is a monomer which yields a clear single-phase solution when mixed with deionized water at 25° C. at a concentration of 5 weight percent. A “hydrophilic component” is a monomer, macromer, prepolymer, initiator, cross-linker, additive, or polymer which yields a clear single-phase solution when mixed with deionized water at 25° C. at a concentration of 5 weight percent. A “hydrophobic component” is a monomer, macromer, prepolymer, initiator, cross-linker, additive, or polymer which is slightly soluble or insoluble in deionized water at 25° C.

A “macromonomer” or “macromer” is a macromolecule that has one group that can undergo chain growth polymerization, such as free radical polymerization, thereby creating a repeating unit in the chemical structure of the target macromolecule. Typically, the chemical structure of the macromer is different than the chemical structure of the target macromolecule, that is, the repeating unit of the macromer's pendent group is different than the repeating unit of the target macromolecule or its mainchain. The difference between a monomer and a macromer is merely one of chemical structure, molecular weight, and molecular weight distribution of the pendent group. Macromers may be hydrophilic, e.g., when the macromolecule is a polyether such as poly(ethylene glycol) or hydrophobic, e.g., when the macromolecule is a poly(dialkylsiloxane).

A “cross-linking agent” or “crosslinker” is a di-functional or multi-functional monomer which can undergo free radical polymerization at two or more locations on the molecule, thereby creating branch points and a polymeric network. The two or more polymerizable functionalities on the crosslinker may be the same or different and may, for instance, be independently selected from vinyl groups (including allyl), (meth)acrylate groups, and (meth)acrylamide groups. Common examples are ethylene glycol dimethacrylate, tetraethylene glycol dimethacrylate, trimethylolpropane trimethacrylate, methylene bisacrylamide, triallyl cyanurate, and the like.

A “prepolymer” is a reaction product of monomers (or macromers) which contains polymerizable groups capable of undergoing further reaction to form a polymer.

A “polymeric network” is a type of polymer that is in the form of a cross-linked macromolecule. Generally, a polymeric network may swell but cannot dissolve in solvents.

“Hydrogels” are polymeric networks that swell in water or aqueous solutions, typically absorbing at least 10 weight percent water at 25° C. “Silicone hydrogels” are hydrogels that are made from at least one silicone-containing component with at least one hydrophilic component. Hydrophilic components may also include non-reactive polymers, such as polyamides.

“Conventional hydrogels” refer to polymeric networks made from monomers without any silicone-containing components. Conventional hydrogels are prepared from reactive compositions predominantly containing hydrophilic monomers, such as 2-hydroxyethyl methacrylate (“HEMA”), N-vinyl pyrrolidone (“NVP”), N, N-dimethylacrylamide (“DMA”), N-vinyl methacetamide (VMA) or vinyl acetate.

As used herein, a “silicone-containing component” or “silicone component” is a monomer, macromer, prepolymer, cross-linker, initiator, additive, or polymer in the reactive composition with at least one silicon-oxygen bond, typically in the form of siloxy groups, siloxane groups, carbosiloxane groups, and mixtures thereof. Examples of silicone-containing components which are useful in this invention may be found in U.S. Pat. Nos. 3,808,178, 4,120,570, 4,136,250, 4,153,641, 4,740,533, 5,034,461, 5,070,215, 5,244,981, 5,314,960, 5,331,067, 5,371,147, 5,760,100, 5,849,811, 5,962,548, 5,965,631, 5,998,498, 6,367,929, 6,822,016, 6,943,203, 6,951,894, 7,052,131, 7,247,692, 7,396,890, 7,461,937, 7,468,398, 7,538,146, 7,553,880, 7,572,841, 7,666,921, 7,691,916, 7,786,185, 7,825,170, 7,915,323, 7,994,356, 8,022,158, 8,163,206, 8,273,802, 8,399,538, 8,415,404, 8,420,711, 8,450,387, 8,487,058, 8,568,626, 8,937,110, 8,937,111, 8,940,812, 8,980,972, 9,056,878, 9,125,808, 9,140,825, 9,156,934, 9,170,349, 9,217,813, 9,244,196, 9,244,197, 9,260,544, 9,297,928, and 9,297,929. These patents are hereby incorporated by reference in their entireties. Representative examples of silicone-containing components are mono-n-butyl terminated monomethacryloxypropyl terminated polydimethylsiloxane (mPDMS), mono-n-butyl terminated mono-(2-hydroxy-3-methacryloxypropyloxy)-propyl terminated polydimethylsiloxane (OH-mPDMS), 3-(3-(1,1,1,3,5,5,5-heptamethyltrisiloxan-3-yl) propoxy)-2-hydroxypropyl methacrylate (SiMAA).

An “initiator” is a molecule that can decompose into free radical groups which can react with a monomer to initiate a free radical polymerization reaction. A thermal initiator decomposes at a certain rate depending on the temperature; typical examples are azo compounds such as 1,1′-azobisisobutyronitrile and 4,4′-azobis(4-cyanovaleric acid), peroxides such as benzoyl peroxide, tert-butyl peroxide, tert-butyl hydroperoxide, tert-butyl peroxybenzoate, dicumyl peroxide, and lauroyl peroxide, peracids such as peracetic acid and potassium persulfate as well as various redox systems. A photo-initiator decomposes by a photochemical process; typical examples are derivatives of benzil, benzoin, acetophenone, benzophenone, camphorquinone, and mixtures thereof as well as various monoacyl and bisacyl phosphine oxides and combinations thereof.

The terms “reactive mixture” and “reactive monomer mixture” refer to the mixture of components (both retained and non-retained) that when subjected to polymerization conditions, form a polymeric network, for instance, in the form of a contact lens. The reactive mixture may comprise retained components such as monomers, macromers, prepolymers, cross-linkers, and initiators; additives such as wetting agents; polymers such as polyamides; dyes, pigments, or tints, such a “visibility tints” which make contact lenses recognizable in a package; light-absorbing compounds such as ultraviolet, high energy visible, and/or photochromic absorbers which may protect the eye from harmful radiation and/or modify vision, either statically or dynamically, based on illumination conditions; pharmaceutical compounds; and/or nutraceutical compounds, any of which may be reactive or non-reactive but are capable of being retained within the resulting polymeric network. The reactive mixture may also contain non-retained components which are intended to be removed from the polymeric network, prior to any use, such as diluents. Diluents are solvents and solvent mixtures that are used to dissolve and dilute a reactive monomer mixture. Diluents can be water based or organic solvent based depending on the composition of the reactive mixture. Diluents can be any organic solvents or mixtures thereof, including aqueous solutions. The concentrations of the components of a reactive mixture are expressed as weight percentages of all retained components in the reactive mixture, therefore excluding non-retained components such as diluent. When diluents are used, their concentrations are expressed as weight percentages based upon the amount of all components in the reactive mixture (including the diluent).

“Reactive components” are the components in the reactive monomer mixture which become part of the structure of the polymeric network of the resulting composition. “Retained components” are the polymerizable compounds (such as monomers, macromers, oligomers, prepolymers, and cross-linkers) in the reactive mixture, as well as any other components in the reactive mixture which are intended to substantially remain in the polymeric network after polymerization and all work-up steps (such as extraction steps) and packaging steps have been completed. Retained components may be retained in the polymeric network by covalent bonding, hydrogen bonding, electrostatic interactions, the formation of interpenetrating polymeric networks, or any other means. Components that are intended to release from the polymeric network once it is in use are still considered “retained components.” For example, pharmaceutical or nutraceutical components in a polymeric network which are intended to be released during use are considered “retained components.” Components that are intended to be removed from the polymeric network during the manufacturing process (e.g., by extraction), such as diluents, are “non-retained components.”

“Polyamides” may comprise both acyclic and cyclic polyamides, including homopolymers and copolymers. Examples of typical polyamides are polyvinylpyrrolidone (PVP), polyvinylmethyacetamide (PVMA), polydimethylacrylamide (PDMA), polyvinylacetamide (PNVA), poly(hydroxyethyl(meth)acrylamide), polyacrylamide, and mixtures thereof. Polyamides are typically used as internal wetting agents and are disclosed in patents U.S. Pat. Nos. 6,367,929, 6,822,016, 7,052,131, 7,666,921, 7,691,916, 7,786,185, 8,022,158, and 8,450,387.

Unless otherwise indicated, numeric ranges, for instance as in “from 2 to 10” or as in “between 2 and 10” are inclusive of the numbers defining the range (e.g., 2 and 10).

Unless otherwise indicated, ratios, percentages, parts, and the like are by weight.

As used herein, the term “about” refers to a range of +/−10 percent of the number that is being modified. For example, the phrase “about 10” would include both 9 and 11.

As used herein, the term “contact lens” refers to an ophthalmic device that can be placed on the cornea of a human eye. Contact lenses may provide vision, cosmetic, and/or therapeutic benefits. Contact lenses can be of any appropriate material known in the art. To make contact lenses more comfortable, technologies have been developed to make contact lenses from hydrogels. Hydrogels are polymeric networks that contain water. The properties of hydrogels can be controlled and varied by their chemical composition, crosslink density, water content, and morphology. As a result, hydrogels have been developed with a balance of physical and mechanical properties suitable for making soft contact lenses. First, there are contact lenses made of hydrogels that do not contain any silicone-containing components. Examples of such conventional hydrogels are etafilcon, omafilcon, nelfilcon, and nesofilcon, all of which have water contents over fifty weight percent. Conventional hydrogels are typically isotropic materials. One deficiency of conventional hydrogels is their relatively low oxygen gas permeability, which in turn can affect the general health of the cornea. To address this, there are contact lenses made of silicone hydrogels which exhibit higher oxygen gas permeabilities than conventional hydrogels as well as a balance of physical and mechanical properties suitable for making soft contact lenses. Silicone hydrogels are hydrogels that are made from at least one silicone-containing component with at least one hydrophilic component. The silicone-containing component contains at least one silicon-oxygen bond, typically in the form of siloxy groups, siloxane groups, carbosiloxane groups, and mixtures thereof. Examples of such silicone hydrogels are lotrafilcon, balafilcon, galyfilcon, senofilcon, narafilcon, comfilcon, somofilcon, delefilcon, samfilcon, stenfilcon, fanfilcon, formofilcon, verofilcon, kalifilcon, lehfilcon, and serafilcon. Silicone hydrogels can have water contents above and below fifty weight percent and are typically phase separated materials. Some commercial silicone hydrogel contact lenses are coated. The present invention is directed to cosmetic contact lenses made from either conventional hydrogels or silicone hydrogels.

All contact lenses have a central optical zone surrounded by a peripheral zone having a lens edge. The optical zone comprises an optical design for the correction of refractive errors such as myopia, hyperopia, astigmatism, and presbyopia. The peripheral zone comprises a mechanical design that facilitates the insertion and removal of the lens from an eye, that provides an interphase between the optical and mechanical designs, and optionally, that includes rotational stabilization features for toric lenses. The design of the lens edge is also important with regards to comfort.

The term “cosmetic contact lens” refers specifically to a soft contact lens that modifies the appearance of the eye when the cosmetic contact lens is worn. Cosmetic contact lenses may be fabricated from hydrogels or silicone hydrogels. In cosmetic contact lenses, the peripheral zone further comprises a pattern of colors and shapes that change the appearance of the eye when the cosmetic contact lenses are worn. The pattern is in the form of an annulus circumscribing the optical zone. The pattern typically overlays the iris and is composed of colorants that absorb, reflect, or scatter light that change the observed color and texture of the iris. By using white reflective colorants, the pattern may also overlay the sclera and thereby brighten its appearance. For people not requiring any vision correction, plano cosmetic contact lenses can be worn solely for their cosmetic effects. The present invention is directed to cosmetic contact lenses having elliptical dot patterns that overlay the iris of an eye.

As used herein, the term “human population” refers to a group or subgroup of people, of any number of subjects equal to or greater than one person, characterized by any demographic and/or geographical means. For example, a human population may be selected from a pediatric, adolescent, or adult population, or across all age groups, or from a global, continental, national, regional, or any combinations thereof. Any anatomical structure of the human body, for example, the diameter of the iris of an eye, can be measured on the individuals of a human population and then averaged for said human population. In this way, the average iris diameter can be calculated using any number of human subjects within a defined human population. For a custom or personalized cosmetic contact lens for a single person, the average iris diameter can be calculated by measuring the diameters of both of the person's irises and dividing by two.

As used herein, the term “elliptical dot pattern” is a pattern made of elliptical dots. Elliptical dot patterns may be incorporated into cosmetic contact lenses, for instance, by pad printing the elliptical dot pattern onto a contact lens mold and then encapsulating the pattern into the contact lens during the curing process. Elliptical dot patterns are made of elliptical dots in the shape of ellipses having a major and a minor axis. The major axis is the longest diameter of the ellipse going through its center from one end to the other, whereas the minor axis is the shortest diameter of ellipse crossing through the center. The major and minor axes are perpendicular to one another. When the major and minor axes are equal, the ellipses are circles. The elliptical dot pattern may be comprised of both elliptical and circular dots, which may also overlap to form other shapes when more than one print layer is used.

The term “negative space” is the space (or area in two dimensions) in-between the dots of an elliptical dot pattern. In other words, the negative space is the unprinted space (or area) between the dots. The elliptical dot pattern may be described by either its dot pattern or its negative space or both. Both the dots and the negative space may be intentional design elements or features of the pattern.

As used herein, the term “colorant” refers to a dye, tint, and/or pigment, both reactive and non-reactive, used in an ink. A colorant is not a visibility tint which is used to make the contact lens visible in a package.

The term “ink” refers to a dispersion or solution comprising at least one colorant used to print the elliptical dot pattern. Inks may include other components such as binding polymers, surfactants, and the like that improve the printing process. The term “clear coat ink” refers to an ink formulation devoid of any colorant and is used to print a “clear layer” or a “clear coat.” Clear layers or clear coats are used as primer coatings on which patterns are printed using inks. Clear layers may be applied to contact lens molds or in-between print layers.

The term “binding polymer” or “binding copolymer” refers to a component in an ink that binds with the colorant and thereby making the ink more stable either before printing, after printing, or both. Binding polymers or copolymers may control the rate of diffusion of reactive monomer mixtures into and through the clear or printed layers.

The elliptical dot patterns of the invention are made by pad printing and are composed of elliptical dots and negative space. Elliptical dot patterns are usually rendered in two-dimensional space (even if they are eventually printed on curved surfaces such as contact lens molds), and as a result, negative space is the unprinted area between the dots on a two-dimensional image. The relative amounts of printed dots and negative space can be measured by quantitative image analysis and expressed in terms of percentages of the total area of the pattern or portion of the pattern, for instance, within the apparent limbal ring.

The quantitative image analysis may, for instance, be performed in Adobe Illustrator 2023, version 27.9 and Adobe Photoshop 2024, version 25.0.0 as described below for determining the amount of negative space in the outermost annulus of an elliptical dot pattern. In Adobe Illustrator, an image of a solid black annulus having the desired inner and outer diameters of the outermost annulus of an elliptical dot pattern is created. This image is used to determine the total area of the outermost annulus. Then, a white image of the elliptical dot pattern is pasted and centered overlying the black annulus. After selecting both objects, the intersect option on the pathfinder panel is clicked, thereby creating a black composite image composed only of the intersecting or overlapping portions of the black annulus and the elliptical dot pattern. A 15-millimeter white circle is created and centered over the composite image. With both objects selected, the white circle is resized to 60 millimeters. Then, the enlarged circle is deleted. The resized, composite image is saved as JPG image file at 300 pixels per inch for a final output image size of 709 pixels by 709 pixels.

In Adobe Photoshop, the black composite image is opened. Thereafter, the area of the black composite image is measured by choosing the color range from the menu, using the eye dropper tool in the pop-up window to select the black area of the composite image, and clicking okay. The measurement log is opened by clicking window/measurement and then clicking the record measurement button to capture the selected black area, representing the area of printed elliptical dots in the outermost annulus of the pattern. The percentage of the area of the outermost annulus that is printed with elliptical dots is calculated by dividing the recorded black area of the composite image by the area of the solid black annulus created in Adobe Illustrator times one hundred percent. The percentage of the area of the outermost annulus that is negative space is equal to one hundred percent minus the percentage of the area printed with elliptical dots.

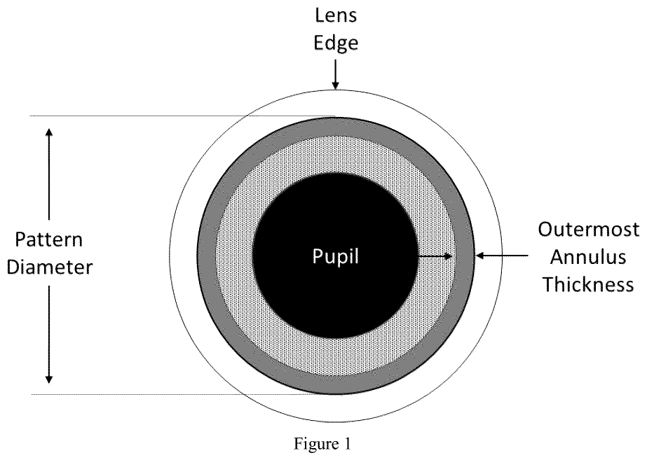

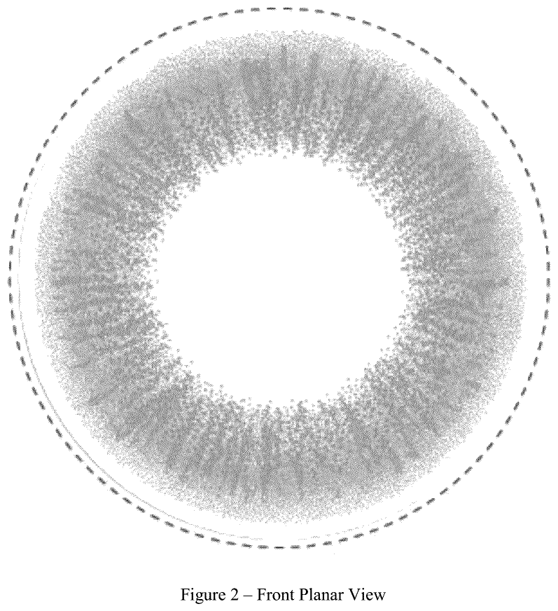

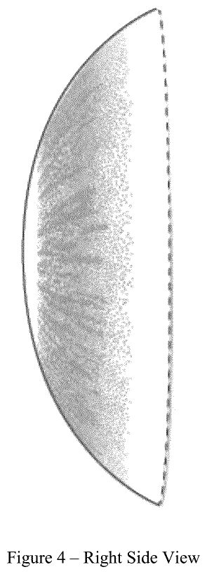

In accordance with one exemplary aspect, the invention provides a cosmetic contact lens comprising an elliptical dot pattern, wherein the elliptical dot pattern has a diameter equal to or greater than 8 millimeters and has a negative space between 70 percent and 100 percent in an outermost annulus, said outermost annulus having a thickness between 0.2 millimeters and 2.0 millimeters. As used herein, the “outermost annulus” refers to a circumferential band in the periphery of the elliptical dot pattern as shown schematically in FIG. 1. The elliptical dot pattern can have a plurality of features such as bands, spokes, spikes, waves, webs, spots and the like, depending on the dot density and location, provided that the negative space in the outermost annulus of the pattern is between 70 percent and 100 percent. In another embodiment, the negative space of the outermost annulus is between 80 percent and 100 percent. The outermost annulus is intended to overlay the corneal limbus of an eye. An exemplary cosmetic contact lens is shown in FIGS. 2-4 from a front planar, left-side, and right-side views, respectively. The dotted line in FIG. 2 represents the cosmetic contact lens edge.

The outermost annulus may have a thickness between 0.5 millimeters and 1.5 millimeters. The diameter of the elliptical dot pattern may be between 9 millimeters and 14 millimeters and preferably may be between 11 millimeters and 13 millimeters.

In accordance with another exemplary aspect, the invention provides a cosmetic contact lens comprising an elliptical dot pattern wherein the negative space of the pattern creates an apparent limbal ring when the pattern overlays an iris of an eye. As used herein, an “apparent limbal ring” refers to the cosmetic effect of creating the appearance of a limbal ring by wearing a cosmetic contact lens having an elliptical dot pattern of this invention. As noted above, a limbal ring is a dark colored ring around the periphery of the iris, also referred to as the corneal limbus, creating a distinct border between the iris and the sclera of the eye, providing greater contrast and making the iris appear more colorful. The apparent limbal ring coincides with the outermost annulus of the elliptical dot pattern and therefore shares the identical design elements with regards to geometry and negative space. The negative space within the apparent limbal ring may be between 70 percent and 100 percent. The negative space within the apparent limbal ring may be between 80 percent and 100 percent. The negative space within the apparent limbal ring can increase radially from the center of the lens, and this gradient of negative space can be different at different locations in the elliptical dot pattern. Furthermore, the thickness of the apparent limbal ring can be between 0.2 millimeters and 2.0 millimeters or between 0.5 millimeters and 1.5 millimeters.

The invention also provides a cosmetic contact lens comprising an elliptical dot pattern that includes negative space, wherein the negative space creates an apparent limbal ring when the pattern overlays an iris of an eye, wherein the diameter of the elliptical dot pattern is equal to an average iris diameter of a human population. The average iris diameter can be calculated from a population representative of the target cosmetic contact lens wearer and may be found in a technical publication.

The invention further provides a cosmetic contact lens comprising an elliptical dot pattern, wherein the negative space of the pattern creates an apparent limbal ring when the pattern overlays an iris of an eye, and wherein the diameter of the elliptical dot pattern is equal to or greater than 8 millimeters, or between 9 millimeters and 14 millimeters, or preferably between 11 millimeters and 13 millimeters.

The apparent limbal ring is formed by a combination of the elliptical dot pattern, the color of the underlying iris in the negative space of the elliptical dot pattern, and the color difference between the elliptical dot pattern and the underlying iris. In 1976, the Commission on Illumination developed a color standard for quantitatively comparing the differences between colors as perceived by humans. The standard is known as the 1976 CIEL*a*b* color space which assigns three dimensional coordinates (L, a*, b*) to every color. The L* coordinate represents lightness ranging from zero (black) to 100 (white) of a target color. The coordinates a* and b* represent chromaticity with no specific numeric limits. Negative a* values correspond with the amount of green in the target color, and positive a* values correspond with the amount of red in the target color. On the other hand, negative b* values correspond with the level of blue in the target color, and positive b* values correspond with the level of yellow in the target color. In the 1976 CIEL*a*b* color space, the “Delta E” value (ΔE) is the distance between colors, or rather the distance between the colors' coordinates (L, a*, b*), and is measure of the color difference as perceived by humans. For two colors having 1976 CIEL*a*b* color space coordinates (L*₁, a*₁, b*₁) and (L*₂, a*₂, b*₂), “Delta E” is calculated using the Formula I below:

$$Δ E = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}} \qquad Formula I$$

To determine the ΔE values required to form an apparent limbal ring, L*a*b* values were measured for three different cosmetic contact lenses having gray, gold, or brown elliptical dot patterns that were placed on four different colored eye models. Pictures were taken of the cosmetic contact lens on the eye model using a digital camera. The color image quality of the picture should be at least 140 pixels per inch. The color image of the inventive cosmetic lens on the eye model is opened in Adobe Photoshop 2022, version 23.0.0. Using the color picker tool, a point in the limbus region of the iris, devoid of any cosmetic pattern, is selected. Double clicking the color box reveals a window showing the color selected using the color picker tool. The window shows the color and its respective color values, including L*a*b* values. The L*a*b* values are shown and then recorded as coordinates (L*₁, a*₁, b*₁). Next, using the color picker tool, a point on the cosmetic pattern area substantially devoid of any negative space is selected. The color window of the selected color is opened, the L*a*b* values are shown and then recorded as coordinates (L*₂, a*₂, b*₂). Delta E was then calculated using Formula I (Microsoft Excel may be used). Apparent limbal rings were visible when the ΔE values were between 23 and 79, preferably between 23 and 54, and more preferably between 34 and 54.

The elliptical dots which comprise the elliptical dot pattern of the cosmetic contact lens of this invention have major axes between 10 micrometers and 200 micrometers, between 25 micrometers and 150 micrometers, or between 30 micrometers and 120 micrometers. The elliptical dots can also be circles (circles are ellipses in which the major and minor axes are equal). The elliptical dot pattern can further comprise dots of non-elliptical shapes.

The elliptical dot pattern can be formed by pad printing using an ink comprising a colorant. The ink can be a dispersion or solution comprising at least one colorant. The colorant can be a dye, tint, and/or pigment, either reactive or non-reactive. The colorant is preferably selected from the group consisting of iron oxides, titanium dioxide, mica pigments, phthalocyanines, carbazole violet, and combinations thereof. The ink can also include binding polymers, surfactants, and the like that improve the printing process. Binding polymers are intended to interact with the colorant and thereby make the ink more stable either before printing, after printing, or both. Binding polymers can also control the rate of diffusion of reactive monomer mixtures into and through clear or printed layers. A clear coat ink is an ink formulation devoid of any colorant and is used to print a “clear layer” or a “clear coat.” Clear layers or clear coats are used as primer coatings on which patterns are printed using inks. Clear layers may be applied to contact lens molds or in-between print layers.

The elliptical dot pattern may be formed by pad printing using one or more print layers individually composed of elliptical dot patterns. The print layers can overlap and create other geometric shapes. In this way, the elliptical dot pattern can vary radially and circumferentially.

In accordance with yet another aspect, the invention provides a cosmetic contact lens having an elliptical dot pattern made from hydrogels or silicone hydrogels, which can further include or incorporate visibility tints for handling purposes, ultraviolet light absorbers and/or high energy visible light absorbers to protect eyes against photochemical damage, internal wetting agents such as polyamides to increase water content and comfort, and the like.

Such cosmetic contact lens can also be coated. Such cosmetic contact lenses can further comprise an optical zone in the center of the lens where there is no elliptical dot pattern. The optical zone can be designed to correct refractive errors such as myopia, hyperopia, astigmatism, and presbyopia.

### Method of Designing an Elliptical Dot Pattern

The invention provides a method of designing an elliptical dot pattern comprising the steps (a) selecting a diameter for an elliptical dot pattern, said diameter being equal to or greater than 8 millimeters; (b) selecting a thickness for an outermost annulus of the elliptical dot pattern between 0.2 millimeters and 2.0 millimeters; and (c) creating an elliptical dot pattern having a negative space between 70 percent and 100 percent in the outermost annulus, wherein the elliptical dot pattern surrounds an optical zone. The diameter of the elliptical dot pattern may be between 9 millimeters and 14 millimeters or between 11 millimeters and 13 millimeters. The thickness of the outermost annulus may be between 0.5 millimeters and 1.5 millimeters. The negative space of the outermost annulus may comprise between 80 percent and 100 percent. The diameter of the elliptical dot pattern may, for instance, be calculated from a human population.

### Method of Making a Cosmetic Contact Lens

The invention also provides a process for making a cosmetic contact lens having an elliptical dot pattern suitable for forming an apparent limbal ring. The method comprises: (a) pad printing an optional clear layer onto the front curve mold of a contact lens mold assembly; (b) pad printing one or more print layers on top of the optional clear layer if present, otherwise on the front curve mold of the contact lens mold assembly, wherein the print layers form an elliptical dot pattern suitable for forming an apparent limbal ring; (c) dispensing a reactive monomer mixture into the front curve mold; (d) positioning a base curve mold on top of the front curve mold, thereby forming the contact lens mold assembly having a cavity in the shape of a contact lens; (e) polymerizing the reactive monomer mixture; (f) removing the cosmetic contact lens from the mold assembly; (g) extracting the cosmetic contact lens; and (h) hydrating the cosmetic contact lens, fors instance with aqueous organic solutions or deionized water. In further steps, the cosmetic contact lens can be packaged and sterilized, typically by autoclaving the package containing the cosmetic contact lens in a suitable packing solution. Examples 1˜4 are representative of this manufacturing process. Alternatively, the pad printing of one or more print layers can be accomplished using inkjet or dot matrix printing processes.

The optional clear layer can be printed on the front curve mold of a contact lens mold assembly in any shape or thickness. Preferably, the clear layer is printed in the shape of an annulus surrounding the optical zone portion of the front curve mold. More information on using clear layers in the fabrication of cosmetic contact lenses can be found in U.S. Pat. Nos. 7,832,860 and 9,798,162 which are hereby incorporated by reference in their entirety.

The print layers may be formed by using inks with a variety of colorants such as iron oxides, titanium dioxide, mica pigments, phthalocyanines, carbazole violet, and combinations thereof. In the absence of a clear layer, the print layers are printed directly onto the surface of the front curve mold. The inks can include binding polymers. The binding polymers are usually prepared from a subset of the reactive components used in the reactive monomer mixture. For hydrogels, the binding polymers may be hydrophilic homopolymers or copolymers. For silicone hydrogels, the binding polymers may contain silicone-containing components and hydrophilic components. More information on using inks with binding polymers in silicone hydrogels in the fabrication of cosmetic contact lenses can be found in U.S. Pat. No. 10,996,491 and U.S. Published Application No. 2021/0079238 which are hereby incorporated by reference in their entireties.

One attribute of the print layers is that they can form an elliptical dot pattern exhibiting a color difference (“Delta E”) between 23 and 79 as compared to the color of the iris of the contact lens wearer. Delta E between the elliptical dot pattern and the iris is preferably between 23 and 54 and more preferably between 34 and 54. In the above process, the reactive monomer mixture can contain only hydrophilic components for form a hydrogel, or can also contain one or more silicone-containing components to form a silicone hydrogel.

### CLAUSES

Certain aspects of the present invention as described herein can be combined in whole or in part. The following clauses list some of the non-limiting embodiments of the disclosure.

Clause 1. A cosmetic contact lens comprising an elliptical dot pattern, wherein the elliptical dot pattern has a diameter equal to or greater than 8 millimeters and has a negative space between 70 percent and 100 percent in an outermost annulus, said outermost annulus having a thickness between 0.2 millimeters and 2.0 millimeters.

Clause 2. The cosmetic contact lens of clause 1, wherein the outermost annulus has a thickness between 0.5 millimeters and 1.5 millimeters.

Clause 3. The cosmetic contact lens of any one of clauses 1-2, wherein the diameter of elliptical dot pattern is between 9 millimeters and 14 millimeters.

Clause 4. The cosmetic contact lens of clause 3, wherein the diameter of elliptical dot pattern is between 11 millimeters and 13 millimeters.

Clause 5. The cosmetic contact lens of any one of clauses 1-4, wherein the negative space of the outermost annulus is between 80 percent and 100 percent.

Clause 6. A cosmetic contact lens comprising an elliptical dot pattern, wherein the negative space of the pattern creates an apparent limbal ring when the pattern overlays an iris.

Clause 7. The cosmetic contact lens of clause 6, wherein the negative space within the apparent limbal ring is between 70 percent and 100 percent.

Clause 8. The cosmetic contact lens of clause 7, wherein the negative space within the apparent limbal ring is between 80 percent and 100 percent.

Clause 9. The cosmetic contact lens of any one of clauses 6-8, wherein the negative space within the apparent limbal ring increases radially from the center of the lens.

Clause 10. The cosmetic contact lens of any one of clauses 6-9, wherein the apparent limbal ring has a thickness between 0.2 millimeters and 2.0 millimeters.

Clause 11. The cosmetic contact lens of clause 10, wherein the thickness of the apparent limbal ring is between 0.5 millimeters and 1.5 millimeters.

Clause 12. The cosmetic contact lens of any one of clauses 6-11, wherein the diameter of the elliptical dot pattern is equal to an average iris diameter of a human population.

Clause 13. The cosmetic contact lens of any one of clauses 6-12, wherein the diameter of the elliptical dot pattern is equal to or greater than 8 millimeters.

Clause 14. The cosmetic contact lens of clause 13, wherein the diameter of the elliptical dot pattern is between 9 millimeters and 14 millimeters.

Clause 15. The cosmetic contact lens of clause 14, wherein the diameter of the elliptical dot pattern is between 11 millimeters and 13 millimeters.

Clause 16. The cosmetic contact lens of any one of clauses 6-15, wherein the color difference (ΔE) between the elliptical dot pattern and the iris is between 23 and 79.

Clause 17. The cosmetic contact lens of clause 16, wherein the color difference (ΔE) between the elliptical dot pattern and the iris is between 23 and 54.

Clause 18. The cosmetic contact lens of clause 17, wherein the color difference (ΔE) between the elliptical dot pattern and the iris is between 34 and 54.

Clause 19. The cosmetic contact lens of any one of clauses 1-18, wherein the elliptical dot pattern comprises elliptical dots having major axes between 10 micrometers and 200 micrometers.

Clause 20. The cosmetic contact lens of clause 19, wherein the elliptical dot pattern comprises elliptical dots having major axes between 25 micrometers and 150 micrometers.

Clause 21. The cosmetic contact lens of clause 20, wherein the elliptical dot pattern comprises elliptical dots having major axes between 30 micrometers and 120 micrometers.

Clause 22. The cosmetic contact lens of any one of clauses 1-21, wherein the elliptical dots are circles.

Clause 23. The cosmetic contact lens of any one of clauses 1-22, wherein the elliptical dot pattern further comprises dots of non-elliptical shapes.

Clause 24. The cosmetic contact lens of any one of clauses 1-23, wherein the elliptical dot pattern is formed by pad printing using an ink comprising a colorant.

Clause 25. The cosmetic contact lens of clause 24, wherein the colorant is selected from the group consisting of iron oxides, titanium dioxide, mica pigments, phthalocyanines, carbazole violet, and combinations thereof.

Clause 26. The cosmetic contact lens of any one of clauses 24-25, wherein the elliptical dot pattern is formed by pad printing using one or more print layers individually composed of elliptical dot patterns.

Clause 27. The cosmetic contact lens of clause 26, wherein the print layers overlap and create other geometric shapes.

Clause 28. The cosmetic contact lens of any one of clauses 1-27, wherein the elliptical dot pattern varies radially and circumferentially.

Clause 29. The cosmetic contact lens of any one of clauses 1-28, wherein the cosmetic contact lens is made from a hydrogel.

Clause 30. The cosmetic contact lens of any one of clauses 1-28, wherein the cosmetic contact lens is made from a silicone hydrogel.

Clause 31. The cosmetic contact lens of any one of clauses 1-30, wherein the cosmetic contact lens is coated.

Clause 32. The cosmetic contact lens of any one of clauses 1-31, further comprising an optical zone in the center of the lens where there is no elliptical dot pattern.

Clause 33. The cosmetic contact lens of clause 32, wherein the optical zone is designed to correct myopia, hyperopia, astigmatism, or presbyopia.

Clause 34. A method of designing an elliptical dot pattern for a cosmetic contact lens comprising the following steps:
(a) selecting a diameter for an elliptical dot pattern, said diameter is equal to or greater than 8 millimeters;
(b) selecting a thickness for an outermost annulus of the elliptical dot pattern between 0.2 millimeters and 2.0 millimeters; and
(c) creating an elliptical dot pattern having a negative space between 70 percent and 100 percent in the outermost annulus, wherein the elliptical dot pattern surrounds an optical zone.

Clause 35. The method of clause 34 wherein the diameter is between 9 millimeters and 14 millimeters.

Clause 36. The method of clause 35, wherein the diameter is between 11 millimeters and 13 millimeters.

Clause 37. The method of any one of clauses 34-36, wherein the thickness of the outermost annulus is between 0.5 millimeters and 1.5 millimeters.

Clause 38. The method of any one of clauses 34-37, wherein the negative space of the outermost annulus is between 80 percent and 100 percent.

Clause 39. The method of any one of clauses 34-38, wherein the diameter is an average diameter calculated from a human population based on demographics, geography, medical conditions, or combinations thereof.

Clause 40. The method of clause 39, wherein the demographics are selected from the group consisting of age, race, gender, ethnicity, income, and combinations thereof.

Clause 41. The method of clause 39, wherein geography is selected from the group consisting of global, continental, national, regional, political, and combinations thereof.

Clause 42. The method of clause 39, wherein the medical conditions are selected from the group consisting of myopia, hyperopia, astigmatism, presbyopia, glaucoma, dry eye, diabetes, and combinations thereof.

Clause 43. A process for making a cosmetic contact lens having an elliptical dot pattern suitable for forming an apparent limbal ring comprising the following steps:
(a) pad printing an optional clear layer onto the front curve mold of a contact lens mold assembly;
(b) pad printing one or more print layers on top of the optional clear layer if present, otherwise on the front mold, wherein the print layers form an elliptical dot pattern suitable for forming an apparent limbal ring;
(c) dispensing a reactive monomer mixture into the front curve mold;
(d) positioning a base curve mold on top of the front curve mold, thereby forming the contact lens mold assembly having a cavity in the shape of a contact lens; and
(e) polymerizing the reactive monomer mixture to form the cosmetic contact lens;
(f) removing the cosmetic contact lens from the mold assembly;
(g) extracting the cosmetic contact lens; and
(h) hydrating the cosmetic contact lens.

Clause 44. The process of clause 43, further comprising the steps of packaging and sterilizing the cosmetic contact lens after the hydration step.

Clause 45. The process of clause 44, wherein the sterilizing step is performed by autoclaving the cosmetic contact lens in a package.

Clause 46. The process of any one of clauses 43-45, wherein the clear layer is an annulus surrounding an optical zone.

Clause 47. The process of any one of clauses 43-46, wherein the reactive monomer mixture comprises one or more silicone-containing components.

Clause 48. The process of clause 47, wherein the clear layer comprises a polymer made from one or more silicone-containing compounds.

### EXAMPLES

The following abbreviations will be used throughout the Examples and have the following meanings:
LED: light emitting diode(s)
Wt. %: weight percent
PPM: parts per million
BC: base curve plastic mold
FC: front curve plastic mold
PS: polystyrene which is the homopolymer of styrene and is used as a plastic mold resin or component and may contain additives
PP: polypropylene which is the homopolymer of propylene and is used as a plastic mold resin or component and may contain additives
TT: Tuftec which is a hydrogenated styrene butadiene block copolymer (Asahi Kasei Chemicals) and is used as a plastic mold resin or component and may contain additives
Z: Zeonor which is a polycycloolefin thermoplastic polymer (Nippon Zeon Co Ltd) and is used as a plastic mold resin or component and may contain additives
RMM: reactive monomer mixture(s)
HEMA: 2-hydroxyethyl methacrylate (Bimax)
DMA: N, N-dimethylacrylamide (Jarchem)
MAA: methacrylic acid (Acros)
mPDMS 1000: mono-n-butyl terminated monomethacryloxypropyl terminated polydimethylsiloxane (Mₙ=1000 grams/mole) (Gelest)
SiMAA: 2-propenoic acid, 2-methyl-2-hydroxy-3-[3-[1,3,3,3-tetramethyl-1-[(trimethylsilyl)oxy]disiloxanyl]propoxy]propyl ester (Toray) or 3-(3-(1,1,1,3,5,5,5-heptamethyltrisiloxan-3-yl) propoxy)-2-hydroxypropyl methacrylate
EGDMA: ethylene glycol dimethacrylate (Esstech)
TMPTMA: trimethylolpropane trimethacrylate (Esstech)
TEGDMA: tetraethylene glycol dimethacrylate (Esstech)
Omnirad 1700: mixture of bis(2,6-dimethoxybenzoyl)-2,4,4-trimethyl pentylphosphineoxide and 2-hydroxy-2-methyl-1-phenyl-propan-1-one
Omnirad 1870: blend of bis(2,6-dimethoxybenzoyl)-2,4,4-trimethyl-pentylphosphineoxide and
AIBN: azobisisobutyronitrile (initiator)
DODT: 1-dodecanethiol (chain transfer agent)
Norbloc: 2-(2′-hydroxy-5-methacrylyloxyethylphenyl)-2H-benzotriazole (Janssen)
Blue HEMA: 1-amino-4-[3-(4-(2-methacryloyloxy-ethoxy)-6-chlorotriazin-2-ylamino)-4-sulfophenylamino]anthraquinone-2-sulfonic acid, as described in U.S. Pat. No. 5,944,853
PVP, PVP K30, PVP K60, PVP K90: poly(N-vinylpyrrolidone) (ISP Ashland)
DIW: deionized water
IPA: isopropyl alcohol
1E2P: 1-ethoxy-2-propanol
IPL: isopropyl lactate
D30: 3,7-dimethyl-3-octanol (Vigon)
3E3P: 3-ethyl 3-pentanol
HEP: 1-(2-hydroxyethyl)-2-pyrrolidone
Borate Buffered Packing Solution: The borate buffered packing solution was composed of 0.84 weight percent sodium chloride, 0.91 weight percent boric acid, 0.24 weight percent sodium borate decahydrate, 0.01 weight percent disodium ethylenediaminetetraacetic acid, and 98 weight percent deionized water.
BAGE: Boric Acid Glycerol Ester (molar ratio of boric acid to glycerol was 1:2) 299.3 grams (3.2 mol) of glycerol and 99.8 grams (1.6 mol) of boric acid were dissolved in 1247.4 grams of a 5% (w/w) aqueous EDTA solution in a suitable reactor and then heated with stirring to 90-94° C. under mild vacuum (2-6 torr) for 4-5 hours and allowed to cool down to room temperature.
Titanium Dioxide: Cosmetic White C47-060 (Chempilots)
Iron Oxide Black: Sicovit Black 85 E172 (Chempilots)
Iron Oxide Brown: Sicovit Brown 75 E172 (Chempilots)
Iron Oxide Red: Sicovit Red 30 E172 (Chempilots)
Iron Oxide Yellow: Sicovit Yellow 10 E172 (Chempilots)
Phthalocyanine Blue: Phthalocyanine Blue 15 (Chempilots)
Phthalocyanine Green: Phthalocyanine Green (Chempilots)
Carbazole Violet: Carbazole Violet 23 (Chempilots)

### Binding Copolymer Synthesis (Hydrogels)

A binding copolymer was made by free radical polymerization methods from HEMA and MAA using AIBN as the initiator and DODT as the chain transfer agent, having about 1.4 weight percent MAA repeating units. The copolymerization conditions can be varied to control the composition, molecular weight and molecular weight distribution of the binding copolymer. The composition was about 1.4 weight percent MAA repeating units, about 96.6 weight percent HEMA repeating units, and about 2 weight percent DODT (binding copolymer #1). The binding copolymer interacts and stabilizes the pigment/dye dispersion.

### Clear Coat Ink (Hydrogels)

A clear coat ink was used to print a clear coat layer onto the front curve mold. The cosmetic pattern was then pad printed onto this clear coat layer. The clear coat ink was prepared by dissolving the binding copolymer #1 in a 4:1 (w/w) solution of IPL: 1E2P in the concentration range from about 20 weight percent to about 40 weight percent. In this example, the binding copolymer #1 concentration was 30 weight percent. The solution viscosity can be adjusted as desired by dilution with 4:1 (w/w) solution of IPL: 1E2P or with 1-propanol. 1-Propanol is preferred.

### Colored Ink Preparations (Hydrogels)

Colored inks were prepared by mixing pigments and/or dyes into the clear base ink for hydrogels (30 weight percent binding copolymer #1) at certain concentrations to impart the desired colors, patterns, and/or effects in a cosmetic contact lens. The concentration of pigments and dyes can vary from about 1 weight percent to about 25 weight percent, depending on the opacity, translucency, or transparency of the printed layer. 1-Propanol can be added after the pigments and dyes have been added to adjust viscosity or modify evaporation rates. In Table A, six colored ink compositions are listed. The concentration of the specific pigment or dye is listed in weight percentages. The Brookfield viscosities of these colored inks were reduced by adding 1-propanol to the initial pigment/dye dispersions so that the Brookfield viscosity was between about 5000 centipoise and about 8000 centipoise, preferably between about 5500 centipoise and 6500 centipoise.

TABLE A
Colored Ink Formulations

| | Colorants | | | | | |
|---|---|---|---|---|---|---|
| | Ink#A1 | Ink#A2 | Ink#A3 | Ink#A4 | Ink#A5 | Ink#A6 |
| | (wt. %) | (wt. %) | (wt. %) | (wt. %) | (wt. %) | (wt. %) |
| | Working | Working | Prophetic | Prophetic | Prophetic | Prophetic |
| | Example | Example | Example | Example | Example | Example |
| Titanium | 6.5 | 0.0 | 1.3 | 1.0 | 0.0 | 3.0 |
| Dioxide | | | | | | |
| Iron Oxide | 2.5 | 1.9 | 0.0 | 0.4 | 0.0 | 5.0 |
| Black | | | | | | |
| Iron Oxide Red | 0.0 | 2.2 | 0.0 | 0.0 | 0.0 | 4.5 |
| Iron Oxide | 0.0 | 5.7 | 10.0 | 0.0 | 5.5 | 0.0 |
| Yellow | | | | | | |
| Phthalocyanine | 0.0 | 0.0 | 0.2 | 0.3 | 0.0 | 1.8 |
| Blue | | | | | | |
| Phthalocyanine | 0.0 | 0.0 | 0.1 | 0.0 | 0.9 | 0.0 |
| Green | | | | | | |

### Example 1 (Hydrogels)

Cosmetic contact lenses, having an elliptical dot pattern designed to overlay an iris and thereby form an apparent limbal ring, were fabricated on an automated pilot manufacturing line capable of pad printing and contact lens fabrication wherein the oxygen gas level was maintained between 0.5 and 5%. The front and base curve molds can be manufactured from any polymer; however, homopolymers, copolymers, and blends of PS, PP, TT, and Z are preferred. For example, the front curve mold was made from polystyrene, and the base curve mold from Zeonor. The front and base curve molds were degassed for about twelve hours prior to use. After the clear coat was printed using the clear coat ink in the of shape of an annulus, located between the optical zone and lens edge, and sufficiently dry (dry enough to deposit the next layer without lifting or changing the clear coat), a print layer cliché having the pattern shown in FIG. 2C was printed onto the clear coat using colored ink #A1. The dot diameters of this first print layer varied from 50 micrometers to 110 micrometers. After the colored ink #A1 was sufficiently dry, a print layer cliché having the pattern shown in FIG. 2D was printed onto the clear coat using colored ink #A2. The average dot diameter of this second print layer was 63 micrometers.

Once print layers were dry, about 100 microliters of a RMM were dosed into the printed front curve mold at ambient temperature. The RMM was prepared by dissolving the reactive components in the relative amounts listed in Table B in BAGE to make a 52:48 (w/w) solution of reactive components to diluent. The base curve mold was then placed on top of the front curve mold. The pallets containing the mold assemblies were then moved into the curing tunnel at 60-70° C. The time between dosing the RMM and entering the curing chamber was controlled to allow the RMM to diffuse into the printed layers without smearing. The RMM was photopolymerized around the printed layers using 420 nanometer LEDs which were positioned above the pallets to achieve an intensity of about 5 mW/cm² for about 4 minutes.

TABLE B
Reactive Monomer Mixture

| Component | Weight Percent |
|---|---|
| HEMA | 95 |
| MAA | 2 |
| EGDMA | 0.8 |
| TMPTMA | 0.08 |
| Norbloc | 1 |
| Blue-HEMA | 0.02 |
| Omnirad 1700 | 1.1 |
| Σ Components | 100 |

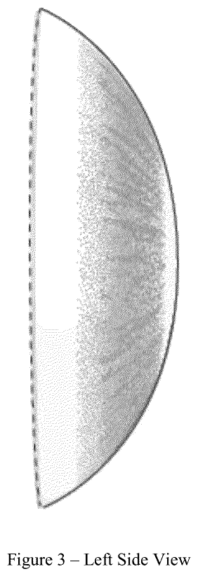

The printed lenses were mechanically de-molded with most lenses adhering to the FC and released from the BC and hydrated by submerging the lenses into DIW containing about 800 ppm Tween 80 at 70° C. for about one hour followed by equilibration in borate buffered packing solution at 70° C. for another hour. A person of ordinary skill recognizes that the exact lens release process can be varied depending on the lens formulation and mold materials. The purpose of the lens release process is to release all lenses without defects and transition from diluent swollen networks to the packing solution swollen hydrogels. The lenses were transferred into foil heat sealed blister packages and subsequently sterilized by autoclaving at 124° C. for about 18 minutes. When the printed lens was placed on an artificial eye having a brown iris, an apparent limbal ring can be seen as shown in FIG. 3C.

### Example 2 (Hydrogels-Prophetic)

Example 1 is repeated except that the first print layer is applied using ink #A3 and cliché having the pattern shown in FIG. 2C, and the second print layer is applied using ink #A4 and cliché having the pattern shown in FIG. 2D.

### Example 3 (Hydrogels-Prophetic)

Example 1 is repeated except that the first print layer is applied using ink #A5 and cliché having the pattern shown in FIG. 2A, and the second print layer is applied using ink #A6 and cliché having the pattern shown in FIG. 2B.

### Binding Copolymer Synthesis (Silicone Hydrogels)

An AIBN solution was prepared by dissolving 4 grams of AIBN in 300 grams of 1-propanol. The AIBN solution was deaerated with nitrogen gas for 15-20 minutes prior to its use. A monomer solution was prepared by dissolving 98 grams of HEMA and 98 grams of mPDMS in 91 grams of 1-propanol. The monomer solution was deaerated with nitrogen gas for 15-20 minutes prior to its use.

A two-liter jacketed reactor containing 279 grams of 1-propanol was heated to 70° C. under a nitrogen gas atmosphere using a water bath. Using a Watson-Marlow pump, the AIBN and monomer solutions were added to the reactor over four hours. The reaction mixture was stirred overnight after which the temperature was reduced to 50° C., and monomer conversion was monitored by Fourier Transform Infrared Spectroscopy until the carbon-carbon double bond band disappeared. Complete conversion required about 24 hours.

The reaction mixture was transferred into a clear glass jar. The copolymer was isolated by precipitation into water, suction filtration, and vacuum drying to obtain about 182 grams of product (binding copolymer #2).

### Clear Coat Inks (Silicone Hydrogels-Prophetic)

Clear coat inks are prepared by dissolving binding copolymer #2 for silicone hydrogels in a solvent system comprising various amounts of HEP, IPL, D30 and/or 1E2P. The clear coat inks may also contain various amounts of PVP K60 and PVP K30, especially when reactive monomer mixtures contain PVP K90. Exemplary clear inks for silicone hydrogels are listed in Table C.

TABLE C

| | Clear | Clear | Clear | Clear |
|---|---|---|---|---|
| | Coat C1 | Coat C2 | Coat C3 | Coat C4 |
| Component | (weight %) | (weight %) | (weight %) | (weight %) |
| Binding | 8.4 | 7.3 | 3 | 3 |
| Copolymer | | | | |
| #2 | | | | |
| PVP K60 | 0 | 0 | 5.7 | 6.75 |
| PVP K30 | 19.6 | 14.7 | 23.3 | 20.25 |
| HEP | 0 | 0 | 6.8 | 0 |
| IPL | 36 | 0 | 0 | 0 |
| D3O | 0 | 7.7 | 0 | 23.1 |
| 1E2P | 36 | 70.3 | 61.2 | 46.9 |
| Total | 100 | 100 | 100 | 100 |

### Colored Ink Preparations (Silicone Hydrogels—Prophetic)

Colored inks are prepared by dispersing/dissolving colorants in one of the clear coat inks C1-C4 at the exemplary concentrations shown in Table D.

TABLE D

| | Colorants | | | | | |
|---|---|---|---|---|---|---|
| | Ink#D1 | Ink#D2 | Ink#D3 | Ink#D4 | Ink#D5 | Ink#D6 |
| | (wt. %) | (wt. %) | (wt. %) | (wt. %) | (wt. %) | (wt. %) |
| | Prophetic | Prophetic | Prophetic | Prophetic | Prophetic | Prophetic |
| | Example | Example | Example | Example | Example | Example |
| Titanium Dioxide | 6.5 | 0.0 | 1.3 | 1.0 | 0.0 | 3.0 |
| Iron Oxide Black | 2.5 | 1.9 | 0.0 | 0.4 | 0.0 | 5.0 |
| Iron Oxide Red | 0.0 | 2.2 | 0.0 | 0.0 | 0.0 | 4.5 |
| Iron Oxide | 0.0 | 5.7 | 10.0 | 0.0 | 5.5 | 0.0 |
| Yellow | | | | | | |
| Phthalocyanine | 0.0 | 0.0 | 0.2 | 0.3 | 0.0 | 1.8 |
| Blue | | | | | | |
| Phthalocyanine | 0 | 0.0 | 0.1 | 0.0 | 0.9 | 0.0 |
| Green | | | | | | |

### Example 4 (Silicone Hydrogels-Prophetic)

Cosmetic contact lenses, having an elliptical dot pattern designed to overlay an iris and thereby form an apparent limbal ring, are fabricated on an automated pilot manufacturing line capable of pad printing and contact lens fabrication wherein the oxygen gas level is maintained between 0.5 and 5%. The front and base curve molds can be manufactured from any polymer; however, homopolymers, copolymers, and blends of PS, PP, TT, and Z are preferred. For example, the front curve mold is made from polystyrene, and the base curve mold from Zeonor. The front and base curve molds are degassed for about twelve hours prior to use. After the annular clear coat is printed, using the clear coat ink C1, located between the optical zone and lens edge, and sufficiently dry (dry enough to deposit the next layer without lifting or changing the clear coat), a print layer cliché having the pattern shown in FIG. 2C is printed onto the clear coat using colored ink #D1. After the colored ink #D1 is sufficiently dry, a print layer cliché having the pattern shown in FIG. 2D is printed onto the clear coat using colored ink #D2. Once print layers are dry, about 100 microliters of a RMM are dosed into the printed front curve mold at ambient temperature. The RMM is prepared by dissolving the reactive components in the relative amounts listed in Table E in D30 to make a 77:23 (w/w) solution of reactive components to diluent. The base curve mold is then placed on top of the front curve mold. The pallets containing the mold assemblies are then moved into the curing tunnel at 60-70° C. The time between dosing the RMM and entering the curing chamber is controlled to allow the RMM to diffuse into the printed layers without smearing. The RMM is photopolymerized around the printed layers using 420 nanometer LEDs which are positioned above the pallets to achieve an intensity of about 5 mW/cm² for about 4 minutes.

TABLE E

| Component | Weight Percent |
|---|---|
| mPDMS 100 | 28 |
| SIMAA | 31 |
| DMA | 22.6 |
| HEMA | 6 |
| PVP K90 | 9 |
| TEGDMA | 1.25 |
| Norbloc | 1.8 |
| Blue HEMA | 0.02 |
| OmniRad 1870 | 0.33 |
| Σ Reactive Components | 100 |

The printed lenses are de-molded with most lenses adhering to the FC and released by submerging the lenses in 70 percent IPA for about one or two hours, followed by washing two times with 70 percent IPA, optionally two times with 25 percent IPA, two times with DI, and finally once with borate buffered packaging solution. Each washing step lasts for about 30 minutes. A person of ordinary skill recognizes that the exact lens release process can be varied depending on the lens formulation and mold materials. The purpose of the lens release process is to release all lenses without defects and transition from diluent swollen networks to the packing solution swollen hydrogels. The lenses are transferred into foil heat sealed blister packages and subsequently sterilized by autoclaving at 124° C. for about 18 minutes. When the printed lens is placed on an artificial eye having a brown iris, an apparent limbal ring can be seen which is similar to the one as shown in FIG. 3C.

1. A cosmetic contact lens comprising an elliptical dot pattern, wherein the elliptical dot pattern has a diameter equal to or greater than 8 millimeters and has a negative space between 70 percent and 100 percent in an outermost annulus, said outermost annulus having a thickness between 0.2 millimeters and 2.0 millimeters.

2. The cosmetic contact lens of claim 1, wherein the outermost annulus has a thickness between 0.5 millimeters and 1.5 millimeters.

3. The cosmetic contact lens of claim 1, wherein the diameter of the elliptical dot pattern is between 9 millimeters and 14 millimeters.

4. The cosmetic contact lens of claim 3, wherein the diameter of the elliptical dot pattern is between 11 millimeters and 13 millimeters.

5. The cosmetic contact lens of claim 1, wherein the negative space in the outermost annulus is between 80 percent and 100 percent.

6. A cosmetic contact lens comprising an elliptical dot pattern, the elliptical dot pattern including a negative space, wherein the negative space creates an apparent limbal ring when the elliptical dot pattern overlays an iris.

7. The cosmetic contact lens of claim 6, wherein the negative space is between 70 percent and 100 percent.

8. (canceled)

9. The cosmetic contact lens of claim 6, wherein the negative space increases radially from the center of the lens.

10. The cosmetic contact lens of claim 6, wherein the apparent limbal ring has a thickness between 0.2 millimeters and 2.0 millimeters.

11. (canceled)

12. The cosmetic contact lens of claim 6, wherein the diameter of the elliptical dot pattern is equal to an average iris diameter of a human population.

13. The cosmetic contact lens of claim 6, wherein the diameter of the elliptical dot pattern is equal to or greater than 8 millimeters.

14-15. (canceled)

16. The cosmetic contact lens of claim 6, wherein the elliptical dot pattern and the iris exhibit a color difference (ΔE) between 23 and 79.

17-18. (canceled)

19. The cosmetic contact lens of claim 1, wherein the elliptical dot pattern comprises elliptical dots having major axes between 10 micrometers and 200 micrometers.

20-21. (canceled)

22. The cosmetic contact lens of claim 1, wherein the elliptical dots are circles.

23. The cosmetic contact lens of claim 1, wherein the elliptical dot pattern further comprises dots of non-elliptical shapes.

24. The cosmetic contact lens of claim 1, wherein the elliptical dot pattern is formed by pad printing using an ink comprising a colorant.

25. The cosmetic contact lens of claim 24, wherein the colorant is selected from the group consisting of iron oxides, titanium dioxide, mica pigments, phthalocyanines, carbazole violet, and combinations thereof.

26. The cosmetic contact lens of claim 24, wherein the elliptical dot pattern is formed by pad printing using one or more print layers individually composed of elliptical dot patterns.

27-28. (canceled)

29. The cosmetic contact lens of claim 1, wherein the cosmetic contact lens is made from a hydrogel.

30. The cosmetic contact lens of claim 1, wherein the cosmetic contact lens is made from a silicone hydrogel.

31-33. (canceled)
